(19) United States
(12) Patent Application Publication
(10) Pub. No.: US 2015/0314693 A1
(43) Pub. Date: Nov. 5, 2015

(54) ELECTRICAL VEHICLE BATTERY RECHARGING SYSTEM

(71) Applicant: Maurice MILLS, Chicago, IL (US)

(72) Inventor: Maurice MILLS, Chicago, IL (US)

(21) Appl. No.: 14/331,808

(22) Filed: Jul. 15, 2014

Related U.S. Application Data
(60) Provisional application No. 61/986,431, filed on Apr. 30, 2014.

(51) Int. Cl. B60L 11/18; B60L 11/08; B60L 11/12

(52) U.S. Cl. CPC B60L 11/1811; B60L 11/12; B60L 11/08

(57) ABSTRACT

An electrical vehicle battery recharging system and method that may include engaging a vehicle start switch in an electrical vehicle system. The method further includes energizing and closing a plurality of sets of programmable relays through a programmable logic controller. The method further includes allowing voltage to flow from a battery across the vehicle start switch to a voltage booster. The method further includes amplifying DC volts to a set of operational parameters for the DC/AC inverter through the voltage booster. The method further includes energizing a set of programmable relays when the voltage is low in the battery. The battery may then be charged by an AC/DC converter battery charger to the battery. The system may allow for the charging of the battery while the vehicle may be in use.

### CROSS-REFERENCE TO RELATED APPLICATION

This application claims the benefit of U.S. provisional application No. 61/986,431, filed Apr. 30, 2014, the contents of which are herein incorporated by reference.

### BACKGROUND OF THE INVENTION

The present invention relates to electrical vehicle batteries and, more particularly, to an electrical vehicle battery recharging system.

Currently, electric vehicles need to be plugged into an electrical outlet for the purposes of recharging the battery or batteries. This requirement restricts time of operation and the distance an electric vehicle can travel in between charges. Current systems are connected to wheels, axels or gear boxes as part of a mechanical system. The current systems suffer damage from normal everyday operations, especially during the winter and spring when there are numerous pot holes in the streets causing wheel and axel gear misalignment due to the numerous gears associated with these wheel and axel systems.

As can be seen, there is a need for a system that allows an electric vehicle battery to be recharged while the electrical vehicle is in operation.

### SUMMARY OF THE INVENTION

In one aspect of the present invention, an electrical vehicle battery recharging system comprises: a programmable logic controller; a plurality of sets of relays connected to the programmable logic controller; a battery; a vehicle start switch; a voltage booster input connected to the vehicle start switch output; a DC/AC inverter having an input connection and a plurality of output connections, wherein the voltage booster connects to the input connection of the DC/AC inverter; an AC/DC converter battery charger; an AC alternator; an AC electric motor connected to the DC/AC inverter output and the AC alternator; and an AC/DC converter/regulator connected to the alternator output, wherein the battery, the vehicle start switch, the alternator, the AC/DC converter/regulator, the AC/DC converter battery charger each connect to the programmable logic controller through at least one set of relays of the plurality of sets of relays.

In another aspect of the present invention, a method for recharging a vehicle battery comprises: engaging a vehicle start switch in an electrical vehicle system; energizing and closing a first set of programmable relays through a programmable logic controller; allowing voltage to flow from a battery across the vehicle start switch to a voltage booster; amplifying DC volts to a set of operational parameters for the DC/AC inverter through the voltage booster; converting the DC volts to at least 120 volts AC for use by an AC electric motor; driving an AC alternator through the AC electric motor, wherein the AC alternator outputs AC voltage to an AC/DC converter/voltage regulator; converting the AC voltage to at least 120 regulated DC volts through the AC/DC converter/voltage regulator, wherein the AC/DC converter/voltage regulator outputs the at least 120 regulated DC volts to a second set of programmable relays; and energizing a third set of programmable relays when the voltage is low in the battery, wherein energizing the third set of programmable relays allows voltage flow from an AC/DC converter battery charger to the battery.

These and other features, aspects and advantages of the present invention will become better understood with reference to the following drawings, description and claims.

### BRIEF DESCRIPTION OF THE DRAWINGS

FIG. 1 is a schematic electrical diagram of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an electrical vehicle battery recharging system and method that may include engaging a vehicle start switch in an electrical vehicle system. The method further includes energizing and closing a plurality of sets of programmable relays through a programmable logic controller. The method further includes allowing voltage to flow from a battery across the vehicle start switch to a voltage booster. The method further includes amplifying DC volts to a set of operational parameters for the DC/AC inverter through the voltage booster. The method further includes energizing a set of programmable relays when the voltage is low in the battery. The battery may then be charged by an AC/DC converter battery charger to the battery. The system may allow for the charging of the battery while the vehicle may be in use.

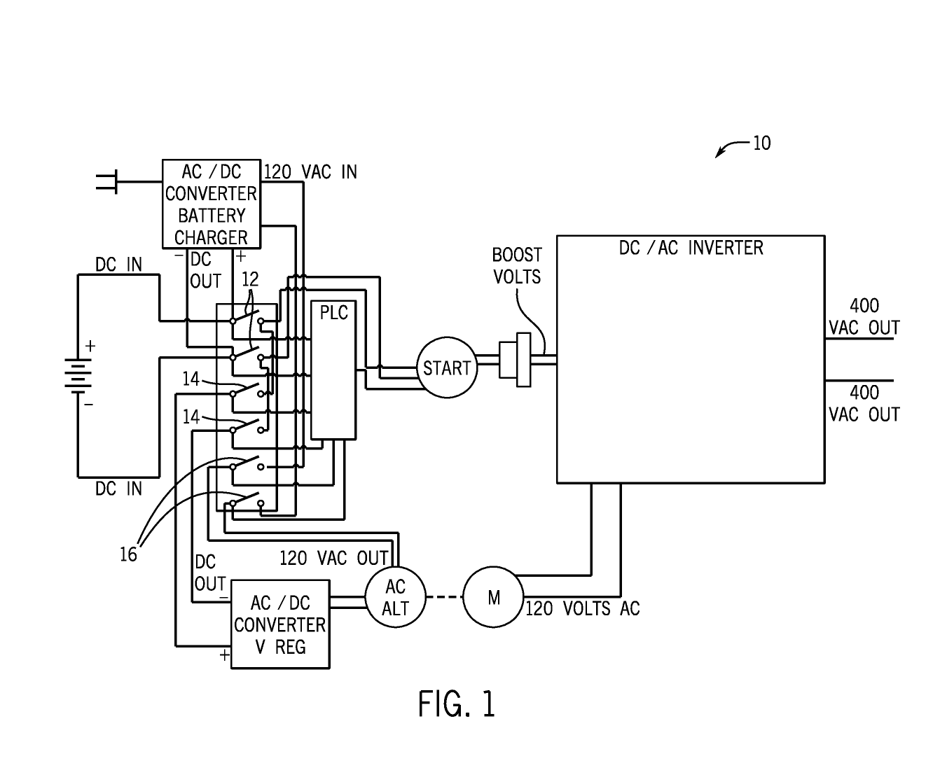

As is illustrated in the FIG. 1, an electrical vehicle battery recharging system 10 may include a programmable logic controller (PLC). A plurality of sets of relays may be connected to the PLC. The plurality of sets of relays may include a first set of programmable relays 12, a second set of programmable relays 14 and a third set of programmable relays 16. A battery, such as a lithium battery may be used. A vehicle start switch may be connected to an input of a voltage booster. An output of the voltage booster may be connected to a voltage splitter and applied to an input of a DC/AC inverter. The DC/AC inverter may be used to convert a DC voltage input into an AC voltage output. An additional AC out circuit may be attached to the voltage splitter of the DC/AC inverter input. An AC/DC converter/voltage regulator may be connected to a vehicle AC alternator output. An AC/DC converter battery charger may be attached to the AC alternator, the battery, and the PLC. A volt sensor may be connected to the PLC and may detect the voltage level of a particular device. The level of volts may determine the proper set of relays that may be opened or closed for proper operation of the vehicle.

A method of use of the present system may include the following. Upon engaging the vehicle start switch, the PLC may energize and close the first set of programmable relays 12 allowing voltage to flow from the battery across the vehicle start switch to the voltage booster input. DC volts to the voltage booster may be amplified by the voltage booster output to operational parameters for the DC/AC inverter input to an additional at least approximately 144 volts. Additional circuitry of the DC/AC inverter may receive applied operational DC volts in from the volts booster via the voltage splitter of approximately 24 volts and may convert it to at least approximately 120 volts AC for use by the AC electric motor. The AC electric motor may drive the AC alternator which may output at least approximately 120 volts AC to the AC/DC converter/voltage regulator which may convert the AC voltage to at least approximately 120 regulated DC volts and outputs the at least approximately 120 regulated DC volts to the second set of programmable relays 14.

The PLC may sense the output of at least approximately 120 volts from the AC/DC converter voltage regulator along the second set of programmable relays 14. The PLC may then energize (close) the second set of programmable relays 14 while at the same time de-energizing (open) the first set of programmable relays 12 allowing continued vehicle operational voltage flow across the vehicle start switch. The charging of the battery may occur when the battery reaches a low level. The PLC may sense the low volts at the volt sensor located at the first set of programmable relays 12. The battery may be charged at this point. The PLC may energize (close) the third set of programmable relays 16 allowing voltage flow to the AC/DC converter battery charger which may charge the battery to full charge. The PLC may then sense a full charge of the battery at the volts sensor and de-energize (open) the third set of programmable relays 16 removing voltage flow to the AC/DC converter battery charger as the vehicle may be in operation.

Upon the depression of the start switch the PLC may energize the first set of programmable relays 12 and may allow DC voltage flow across the start switch from the battery to a boost voltage assembly. This voltage may be a loaded voltage, loaded from approximately 120 volts DC to approximately 92-98 volts DC across the start switch to the boost voltage assembly. The boost voltage assembly may increase the DC voltage from approximately 120 volts DC to approximately 144 regulated volts DC (for cars & light trucks) and may apply it to the DC/AC inverter. The DC/AC inverter may have a voltage splitter which may split the DC voltage into 120 regulated DC volts and 24 regulated DC volts. The 120 regulated DC volts may be applied to a power circuit assembly for vehicle operation. The 24 regulated DC volts may be applied to an additional but separate circuit within the DC/AC inverter. The circuit may receive the 24 volts regulated DC and output 120 volts AC and may be the power source for the electric motor. The electric motor may have a large wheel affixed to it so electric motor may be able to turn a fitted automotive belt. This belt may be connected to the wheel of the AC alternator. The AC alternator may output 120 volts AC to the AC/DC voltage converter/regulator which may convert the output 120 volts AC to DC voltage and may apply it to second set of programmable relays 14. This voltage may be sensed by the PLC. The PLC may then energize the second set of programmable relays 14 and simultaneously de-energize the first set of programmable relays 12, allowing voltage flow across the second set of programmable relays 14 and may prevent over charging of the battery which can result in damage to the battery. This allows the alternator to provide the necessary voltage for continued vehicle operation until the vehicle may be turned off, at which time all relays may be reset to the de-energized position. The AC alternator may also charge the battery when the PLC senses a low voltage state at the first set of programmable relays 12. When low voltage may be sensed from the PLC, the PLC may energize the third set of programmable relays 16 allowing voltage flow across the third set of programmable relay 16 to the AC/DC voltage converter/regulator which may convert it to DC voltage and may apply it to the battery charger circuit and charge the battery back to approximately 100% and then the PLC may de-energize the third set of programmable relays 16, all while the vehicle may be in operation.

An electric vehicle assembly may include additional components such as the DC/AC inverter with a 120 volt AC out additional circuit, an independent electric motor with an attached belt wheel and an AC alternator, along with the PLC and the plurality of programmable relays for the system. The volt booster assembly may be redesigned for proper DC voltage flow out to the DC/AC inverter. The system 10 may be used in various ways for vehicles such as cars, buses, trucks, and the like, of various sizes. The system 10 can also be used for boats, planes, trains and the like. Homes and businesses may also be powered by the system 10.

It should be understood, of course, that the foregoing relates to exemplary embodiments of the invention and that modifications may be made without departing from the spirit and scope of the invention as set forth in the following claims.

What is claimed is:

1. An electrical vehicle battery recharging system comprising:
a programmable logic controller;
a plurality of sets of relays connected to the programmable logic controller;
a battery;
a vehicle start switch;
a voltage booster input connected to the vehicle start switch output;
a DC/AC inverter having an input connection and a plurality of output connections, wherein the voltage booster connects to the input connection of the DC/AC inverter;
an AC/DC converter battery charger;
an AC alternator;
an AC electric motor connected to the DC/AC inverter output and the AC alternator; and
an AC/DC converter/regulator connected to the alternator output, wherein the battery, the vehicle start switch, the alternator, the AC/DC converter/regulator, the AC/DC converter battery charger each connect to the programmable logic controller through at least one set of relays of the plurality of sets of relays.

2. The electric vehicle battery recharging system of claim 1, wherein the plurality of sets of relays comprise a first set of programmable relays, a second set of programmable relays, and a third set of programmable relays.

3. The electric vehicle battery recharging system of claim 1, wherein the programmable logic controller further comprises a volt sensor.

4. The electric vehicle battery recharging system of claim 3, wherein a value from the volt sensor determines which set of programmable relays are opened and closed through the programmable logic controller.

5. A method for recharging a vehicle battery comprising:
engaging a vehicle start switch in an electrical vehicle system;
energizing and closing a first set of programmable relays through a programmable logic controller;
allowing voltage to flow from a battery across the vehicle start switch to a voltage booster;
amplifying DC volts to a set of operational parameters for the DC/AC inverter through the voltage booster;
converting the DC volts to at least 120 volts AC for use by an AC electric motor;
driving an AC alternator through the AC electric motor, wherein the AC alternator outputs AC voltage to an AC/DC converter/voltage regulator;
converting the AC voltage to at least 120 regulated DC volts through the AC/DC converter/voltage regulator, wherein the AC/DC converter/voltage regulator outputs the at least 120 regulated DC volts to a second set of programmable relays; and
energizing a third set of programmable relays when the voltage is low in the battery, wherein energizing the third set of programmable relays allows voltage flow from an AC/DC converter battery charger to the battery.

6. The method of claim 5, wherein the DC/AC inverter receives the DC volts via a voltage splitter.

7. The method of claim 5, wherein the programmable logic controller further comprises a volt sensor, wherein the volt sensor detects the voltage level of the battery which triggers the energizing of the third set of programmable relays.

8. The method of claim 7, further comprising the step of de-energizing the third set of programmable relays once the volt sensor detects a full battery charge, wherein the de-energizing stops voltage flow from the AC/DC converter battery charger.
